(19) United States
(12) Patent Application Publication
(10) Pub. No.: US 2009/0190480 A1
(43) Pub. Date: Jul. 30, 2009

(54) METHODS AND APPARATUS FOR DETECTING RADIO LINK CONTROL PROTOCOL ERRORS AND TRIGGERING RADIO LINK CONTROL RE-ESTABLISHMENT

(75) Inventors: Mohammed Sammour, Montreal (CA); Stephen E. Terry, Northport, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/326,236

(22) Filed: Dec. 2, 2008

Related U.S. Application Data
(60) Provisional application No. 61/012,813, filed on Dec. 11, 2007.

(51) Int. Cl. H04L 12/26; H04W 88/02

(52) U.S. Cl. 370/242; 370/328

(57) ABSTRACT

Methods and apparatus for detecting errors or events in a wireless transmit/receive unit (WTRU) and/or a base station comprising a radio resource control (RRC) layer, a packet data convergence protocol (PDCP) layer, a radio link control (RLC) layer, a medium access control (MAC) layer, and a physical (PHY) layer are disclosed. In addition, the RRC layer may initiate an RLC re-establishment procedure upon detecting an error, or upon receiving an indication of an error or an event detected by any one of the RRC, PDCP, RLC, MAC and PHY layers.

### CROSS REFERENCE TO RELATED APPLICATION

This application claims the benefit of U.S. Provisional Application No. 61/012,813 filed Dec. 11, 2007, which is incorporated by reference as if fully set forth.

### FIELD OF INVENTION

This application is related to wireless communications.

### BACKGROUND

FIG. 1 shows a wireless communication system 100 including a wireless transmit/receive unit (WTRU) 105 and a base station 110, (i.e., an evolved Node-B (eNodeB)). In each of the WTRU 105 and the base station 110 is a third generation partnership project (3GPP) long term evolution (LTE), (i.e., evolved universal terrestrial radio access network (E-UTRAN)), user-plane protocol stack architecture that includes several layers/entities. The WTRU 105 includes a packet data convergence protocol (PDCP) layer/entity(s) 116A, a radio link control (RLC) layer/entity(s) 120A, a medium access control (MAC) layer/entity(s) 125A and a physical (PHY) layer/entity(s) 130A. The base station 110 includes a PDCP layer/entity(s) 115B, an RLC layer/entity(s) 120B, a MAC layer/entity(s) 125B and a physical layer/entity(s) 130B. The PDCP 115, RLC 120 and MAC 125 may also be referred to as sublayers of layer 2 (L2), whereas the PHY layer 130 may also be referred to as layer 1 (L1).

The main services and functions of the RLC layer/entity(s) 120A and 120B include:
1) transfer of upper layer protocol data units (PDUs) supporting acknowledged mode (AM) or unacknowledged mode (UM);
2) transparent mode (TM) data transfer;
3) error correction through automatic repeat request (ARQ);
4) segmentation according to the size of the transport block (TB);
5) re-segmentation of PDUs that need to be retransmitted;
6) concatenation;
7) in-sequence delivery;
8) duplicate detection;
9) protocol error detection and recovery;
10) service data unit (SDU) discard; and
11) RLC re-establishment, (i.e., reset).

The E-UTRAN RLC will perform SDU discard based on a notification from the PDCP layer/entity(s) above it, as opposed to having the RLC have its own SDU timer-based discard mechanism, like in the UTRAN RLC, e.g., Release 6 (R6).

Erroneous Sequence Number

Upon receiving a “status PDU” that has an erroneous sequence number (SN), the RLC 120 will initiate the RLC re-establishment procedure.

E-UTRAN may support an RLC re-establishment procedure. The phrases “RLC re-establishment” and “RLC reset” are interchangeable.

The RLC re-establishment procedure may be signaled via RLC protocol messages or via radio resource control (RRC) messages.

Currently, an inter-eNodeB handover is used as a trigger for re-establishing the RLC in E-UTRAN. The UTRAN RLC reset triggers include:
1) If the number of times an RLC PDU is scheduled for transmission reaches a pre-configured threshold; and
2) Receiving a status PDU including a sequence number outside the interval VT(A)<=“sequence number (SN)”<VT(S), whereby “VT(A)” represents an acknowledgement state variable, and “VT(S)” represents a send state variable.

The UTRAN RLC provides a ‘move receiving window’ (MRW) procedure which is a signal sent by the sending RLC entity to request the receiving RLC entity to move its reception window, and optionally to indicate the set of discarded RLC SDUs, as a result of an RLC SDU discard in the sending RLC entity.

FIG. 2 shows an E-UTRAN RLC status report PDU 200, (hereinafter referred to as a status PDU), that includes an RLC control PDU header and a status PDU payload. The RLC control PDU header includes a data/control (D/C) field 205 and a control PDU type (CPT) field 210. The D/C field 205 indicates whether the status PDU 200 is a data PDU or a control PDU. The CPT field indicates the type of the RLC control PDU. The status PDU payload includes fields 215, 220, 225, 230 and 235. Fields 215 are acknowledgement sequence number (ACK_SN) fields. Fields 220 are extension bit (E1) fields. Fields 225 are negative acknowledgement sequence number (NACK_SN) fields. Fields 230 are extension bit (E2) fields. Fields 235 are segment offset start (SOstart) fields. Fields 240 are segment offset end (SOend) fields.

The ACK_SN field 215 shown in FIG. 2 indicates the higher edge of the status transmitting window. When the transmitting side of an AM RLC entity receives a status PDU, the AM RLC interprets that all AM data (AMD) PDUs, up to the AMD PDU with an SN equal to ACK_SN, have been received by its peer AM RLC entity, excluding those AMD PDUs indicated in the status PDU with a NACK_SN field 225 and portions of AMD PDUs indicated in the status PDU with the NACK_SN field 225, the SOstart field 230 and the SOend field 235.

As shown in FIG. 2, the first E1 field 220 of Octet 2 indicates whether or not a NACK_SN field 225, an E1 field 220 and an E2 field 230 follow. The NACK_SN field 225 indicates the SN of the AMD PDU, (or portions of the AMD PDU), within the status transmitting window that has been detected as lost at the receiving side of the AM RLC entity. The E2 fields 230 indicate whether or not an SOstart field 235 and an SOend field 240 follows.

The SOstart fields 235 (together with the SOend fields 240) indicate the portion of the AMD PDU with an SN that is equal to the NACK_SN field 225, (for which the SOstart field 235 is related to), that has been detected as lost at the receiving side of the AM RLC entity. Specifically, the SOstart fields 235 indicate the position of the first byte of the portion of the AMD PDU in bytes within the data field of the AMD PDU.

The SOend fields 240 (together with the SOstart fields 235) indicate the portion of the AMD PDU with an SN that is equal to the NACK_SN field 225, (for which the SOend field 240 is related to), that has been detected as lost at the receiving side of the AM RLC entity. Specifically, the SOend fields 240 indicate the position of the last byte of the portion of the AMD PDU in bytes within the data field of the AMD PDU.

The RLC state variables currently agreed for E-UTRAN include:

The transmitting side of each AM RLC entity shall maintain the following state variables:

1) VT(A)—Acknowledgement state variable

This state variable holds the value of the SN of the next AMD PDU for which a positive acknowledgment is to be received in-sequence, and it serves as the lower edge of the transmitting window and the status receiving window). It is initially set to 0, and is updated whenever the AM RLC entity receives a positive acknowledgment for an AMD PDU with SN=VT(A).

2) VT(MS)—Maximum send state variable

This state variable equals VT(A)+AM_Window Size, and it serves as the higher edge of the transmitting window.

3) VT(S)—Send state variable

This state variable holds the value of the SN to be assigned for the next newly generated AMD PDU, and it serves as the higher edge of the status receiving window. It is initially set to 0, and is updated whenever the AM RLC entity delivers an AMD PDU with SN=VT(S).

The RLC supports a polling mechanism and is capable of repeating the poll after the expiration of a timer named ‘T_poll_retransmit’ as described below:
Expiration of poll retransmit timer:
   The transmitting side of an AM RLC entity shall:
      Start T_poll_retransmit upon setting the P field for a RLC data PDU to “1”, and store the SN of the corresponding RLC data PDU in memory;
      Stop T_poll_retransmit when it receives either a positive or negative acknowledgement for the corresponding RLC data PDU with the SN it stored in memory;
      Set the P field of the RLC data PDU to be transmitted in the next transmission opportunity if T_poll_retransmit expires.

The E-UTRAN RLC should be able to first detect potential RLC protocol error cases, (e.g., due to unforeseen events). Therefore, several enhanced RLC protocol error detection mechanisms are desired. Furthermore, besides the inter-eNodeB handover trigger, additional triggers for initiating RLC re-establishment are needed to improve overall RLC and/or E-UTRAN operations.

### SUMMARY

This application is related to methods and apparatus for detecting errors or events in a WTRU and/or a base station comprising an RRC layer, a PDCP layer, an RLC layer, a MAC layer, and a PHY layer. In addition, the RRC layer may initiate an RLC re-establishment procedure upon detecting an error, or upon receiving an indication of an error or an event detected by any one of the RRC, PDCP, RLC, MAC and PHY layers.

### BRIEF DESCRIPTION OF THE DRAWINGS

A more detailed understanding may be had from the following description, given by way of example and to be understood in conjunction with the accompanying drawings wherein:

FIG. 1 shows an LTE user-plane protocol stack within a WTRU and a base station of a wireless communication system;

FIG. 2 shows an E-UTRAN RLC status report PDU;

FIG. 3 shows a transmitting side of a WTRU or a base station; and

FIG. 4 shows a receiving side of a WTRU or a base station.

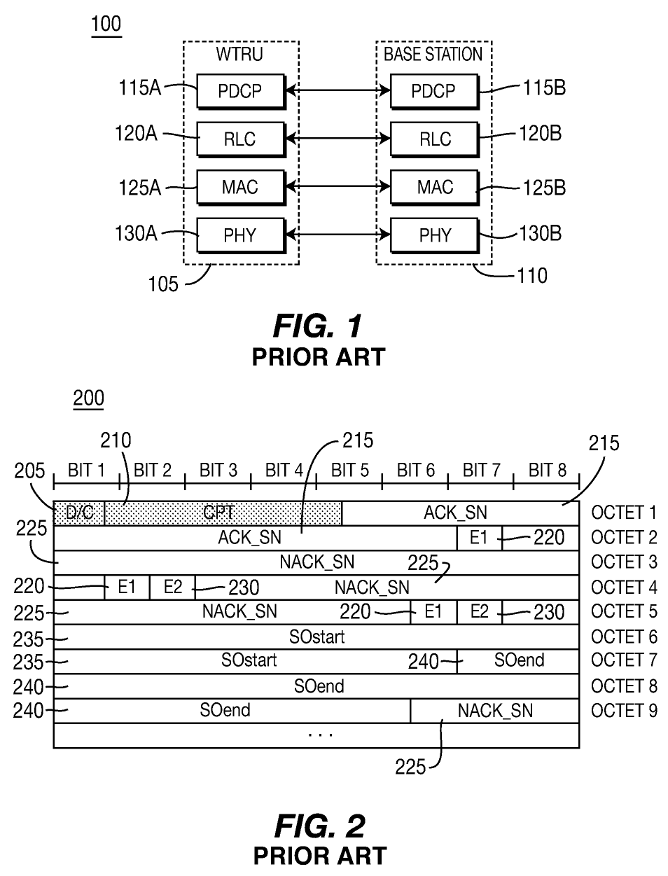

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, an evolved or E-UTRAN Node-B (eNodeB), a site controller, an access point (AP), or any other type of interfacing device capable of operating in a wireless environment.

When referred to hereafter, the terminology “RLC re-establishment” is interchangeable with the terminology “RLC reset”.

The following mechanisms and conditions for detecting RLC protocol errors are presented.

Any status PDU having an “erroneous sequence number” is one that contains an ACK_SN which is outside the interval VT(A)<=ACK_SN<VT(S), or a NACK_SN which is outside the interval VT(A)<=NACK_SN<VT(S). Other variants may tweak the inequality signs, (e.g., use less than or equal, as an example), or add or subtract 1 from some of the quantities, and the like.

If an AM RLC entity receives any status PDU that includes an “erroneous Sequence Number”, it shall discard the status PDU and/or initiate the RLC re-establishment procedure.

Any status PDU having an “erroneous data range” or “erroneous segment range” is one that contains an SOstart that is greater than or equal to the length of the referenced packet, or an SOend that is greater than or equal to the length of the referenced packet, or (SOend—SOstart) is greater than or equal to the length of the referenced packet.

The referenced packet is the packet specified by the NACK_SN field. Basically, in this condition, the AM RLC entity will verify that the segment specified via the SOstart and SOend fields is a valid segment that lies within the total length of the referenced packet.

If an AM RLC entity receives any status PDU that includes an “erroneous segment range”, the status PDU is discarded and/or the RLC re-establishment procedure is initiated.

In earlier UTRAN systems, upon receiving a status PDU indicating a different status for a particular AMD PDU, the status PDU was discarded. Due to the hybrid automatic repeat request (HARQ) assisted ARQ feature of E-UTRAN, (e.g., a local HARQ NACK can be used to trigger ARQ retransmissions), it is possible that the status indicated by a received status PDU will be different than that indicated by the HARQ assistance feature/function.

Thus, when there is a conflict between the status indicated by a received status PDU and the status indicated by the HARQ assistance feature/function, the status PDU may be accepted, (i.e., not discarded), in this case, (i.e., it will supersede HARQ status). However, when there is a conflict between the status indicated by a received status PDU and the status indicated by another previously received status PDU, the new status PDU may be discarded.

A stale transmit window can be detected when VT(A) is not moving, despite repeated (re)transmissions of the SN that has VT(A). In order to detect stale transmit window (stale VT(A) condition), several procedures may be used.

In one example, the number of (re)transmissions may be counted for the PDU whose SN is represented by VT(A). Counting may start either from the moment that the PDU SN is the same as VT(A), or earlier.

Upon having the counter reach a certain threshold, while VT(A) remains stale, (i.e., has not changed), the AM RLC entity may either initiate the RLC re-establishment procedure, or initiate the RLC MRW procedure.

In another example, a timer or a counter may be utilized to detect how long VT(A) remains stale. Such timer or counter can be started upon updating VT(A). There can be a variety of ways in which such timer or counter can be updated. For example, any of the following conditions or their combinations may be used:
1) The timer or counter may be updated at all times; or/and
2) The timer or counter may be updated upon the occurrence of packet (re)transmissions; or/and
3) The timer or counter may be updated only if there is data in the RLC transmit buffer(s); or/and
4) The timer or counter may be updated only if VT(S)=VT(MS), i.e., if the maximum window size is reached.

Upon the expiration of the timer, or having the counter reach a certain threshold, while VT(A) remains stale (i.e. has not changed), the AM RLC entity shall either initiate the RLC re-establishment procedure. Alternatively, the RLC MRW procedure may be initiated.

The number of repeated polling failures may be counted, for example via counting the number of times the poll retransmit timer expired repeatedly, and is used as a criterion for detecting RLC errors, and potentially triggering a re-establishment. A counter C_poll_retransmit may be used to count the number of polling retransmissions. The initial value of this counter is 0. The algorithm operates by incrementing the counter C_poll_retransmit if T_poll_retransmit expires, (or alternatively, if/when repeating/retransmitting the poll). If C_poll_retransmit reaches a threshold, (note: the threshold could be configurable by RRC), the AM RLC entity shall initiate the RLC re-establishment procedure. The following is an exemplary illustration of how overall poll retransmit operations can operate:

The transmitting side of an AM RLC entity shall:
1) start T_poll_retransmit upon setting the P field for a RLC data PDU to “1”, and store the SN of the corresponding RLC data PDU in memory;
2) stop T_poll_retransmit when it receives either a positive or negative acknowledgement for the corresponding RLC data PDU with the SN it stored in memory;
3) set the P field of the RLC data PDU to be transmitted in the next transmission opportunity if T_poll_retransmit expires;
4) increment the counter C_poll_retransmit if T_poll_retransmit expires (or alternatively, if repeating/retransmitting the poll); and
5) if C_poll_retransmit reaches a threshold, (note: the threshold could be configurable by RRC), the AM RLC entity shall initiate the RLC re-establishment procedure.

Other variations of the above procedure are possible, but effectively, repeated polling failures are counted and used as a criterion to trigger RLC re-establishment.

Additional triggers may be used to start or initiate the RLC reset or re-establishment procedure, in addition to those previously described.

Currently, only the inter-eNodeB handover is used as a trigger for re-establishing the RLC in E-UTRAN. In addition to inter-eNB handover, any of the following triggers may be used to initiate the RLC re-establishment) procedure:
1) indication from RRC, (other than an inter-eNodeB handover event);
2) indication from upper layers;
3) indication from PDCP, (e.g., if PDCP is re-established, then it is proposed that RLC will be re-established);
4) radio link failure indication; and
5) any of the triggers/conditions described above.

Furthermore, the RRC may utilize other triggers or events to initiate the RLC re-establishment procedure, in addition to the inter eNodeB handover trigger; for example, the RRC may send an indication to the RLC sublayer instructing it to perform re-establishment when at least one of the following occurs:
1) PDCP re-establishment;
2) MAC reset;
3) Radio link failure; and
4) RLC protocol error(s).

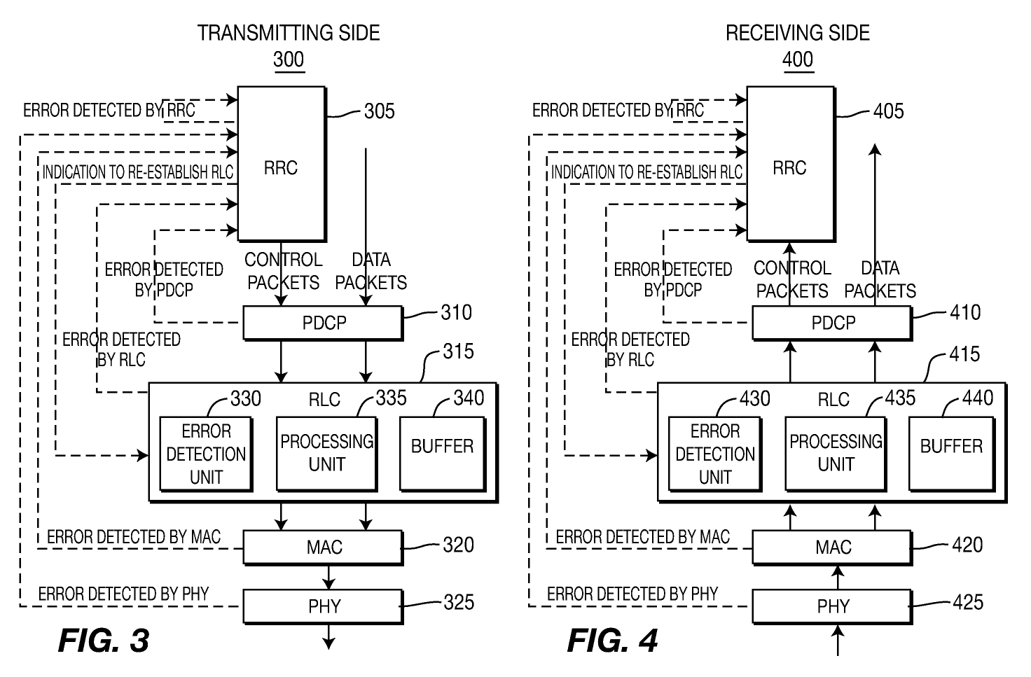

FIG. 3 shows a transmitting side 300, which may be incorporated into a WTRU or a base station. The transmitting side includes an RRC layer/entity 305, a PDCP layer/entity 310, an RLC layer/entity 315, a MAC layer/entity 320 and a PHY layer/entity 325. The RLC layer/entity 315 may include an error detection unit 330, a processing unit 335 and a buffer 340.

As shown in FIG. 3, after any of the RRC 305, PDCP 310, RLC 315, MAC 320 and PHY 325 layer/entities detect an error, the layer/entity that detects the error sends an indication to the RRC 305 regarding the detected error. The RRC 305 subsequently sends an indication to the RLC 315 regarding performing RLC re-establishment. Thus, the RRC layer/entity 305 initiates an RLC re-establishment procedure upon detecting an error, or upon receiving an indication of an error or an event detected by any one of the RRC, PDCP, RLC, MAC and PHY layers.

The error or event may be an erroneous segment range, an excessive number of polling retransmissions or polling failures, a PDCP re-establishment or an error or event resulting from or leading to a PDCP re-establishment, a MAC reset or an error or event resulting from or leading to a MAC reset, a radio link failure or an error or event resulting from or leading to a radio link failure, or an RLC protocol error or an error or event resulting from or leading to an RLC protocol error.

The transmitting side 300 may also include a counter (not shown) that may reside in the RLC layer/entity 315, or anywhere else in the transmitting side 300. The RLC layer/entity 315 may be configured to transmit an indication that a status PDU is required and increment the counter if the status PDU is not received within a predetermined time interval. An RLC re-establishment procedure is initiated if a value indicated by the counter is equal to or greater than a predetermined threshold. A polling field of an RLC data PDU field may include the indication that a status PDU is required.

The RLC layer/entity 315 may be configured to transmit a first indication indicating that a first status PDU is required. If the first status PDU is not received within a predetermined time interval, the counter is incremented and a second indication is transmitted that conveys that a second status PDU is required. An RLC re-establishment procedure is initiated if a value indicated by the counter is equal to or greater than a predetermined threshold. A polling field of an RLC data PDU field may include the first indication that the first status PDU is required. A polling field of an RLC data PDU field may include the second indication that the second status PDU is required.

In the transmitting side 300, a status PDU may be received that includes a negative acknowledgement sequence number (NACK_SN) field, a segment offset start (SOstart) field and a segment offset end (SOend) field. The NACK_SN field indicates a sequence number of a data PDU that was not fully received.

In one procedure, a determination is made as to whether the status PDU has an erroneous segment range by comparing the value of the SOstart field to a length of the data PDU. An RLC re-establishment procedure is initiated and/or the status PDU is discarded if the value of the SOstart field is equal to or greater than the length of the data PDU.

In another procedure, a determination is made as to whether the status PDU has an erroneous segment range by comparing the value of the SOend field to a length of the data PDU. An RLC re-establishment procedure is initiated and/or the status PDU is discarded if the value of the SOend field is equal to or greater than the length of the data PDU.

In yet another procedure, a determination is made as to whether the status PDU has an erroneous segment range by comparing the difference between the SOend and SOstart fields to a length of the data PDU. An RLC re-establishment procedure if the value of the difference between the SOend and SOstart fields is equal to or greater than the length of the data PDU.

FIG. 4 shows a receiving side 400, which may be incorporated into a WTRU or a base station. The receiving side 400 includes an RRC layer/entity 405, a PDCP layer/entity 410, an RLC layer/entity 415, a MAC layer/entity 420 and a PHY layer/entity 425. The RLC layer/entity 415 may include an error detection unit 430, a processing unit 435 and a buffer 440.

As shown in FIG. 4, after any of the RRC 405, PDCP 410, RLC 415, MAC 420 and PHY 425 layer/entities detect an error, the layer/entity that detects the error sends an indication to the RRC 405 regarding the detected error. The RRC subsequently sends an indication to the RLC regarding performing RLC re-establishment.

The following methods of initiating RLC re-establishment procedures may be implemented by either the receiving side 300 or the transmitting side 400. A

On one method, a PDCP re-establishment procedure is initiated, and an RLC re-establishment procedure is initiated after the PDCP re-establishment procedure is initiated.

In another method, a MAC reset is initiated, and an RLC re-establishment procedure is initiated after the MAC reset is initiated.

In yet another method, a radio link failure is detected, and an RLC re-establishment procedure is initiated subsequent to the detection of the radio link failure.

In yet another method, at least one RLC protocol layer is detected, and an RLC re-establishment procedure is initiated subsequent to the detection of the at least one RLC protocol layer.

Although the features and elements are described in the embodiments in particular combinations, each feature or element can be used alone without the other features and elements of the embodiments or in various combinations with or without other features and elements. The methods disclosed may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A wireless communication method of detecting radio link failures, the method comprising:
initiating a radio link control (RLC) re-establishment procedure; and
initiating a packet data convergence protocol (PDCP) re-establishment procedure upon initiating the RLC re-establishment procedure.

2. The method of claim 1 wherein the RLC re-establishment procedure is initiated subsequent to the detection of at least one RLC protocol layer error.

3. The method of claim 1 further comprising:
using a counter to count a number of retransmissions of a protocol data unit (PDU) whose sequence number (SN) is represented by an acknowledgement state variable; and
performing the RLC re-establishment procedure when the counter reaches a certain threshold while the acknowledgement state variable remains the same, wherein the counter is updated upon the occurrence of packet retransmissions.

4. The method of claim 1 further comprising:
using a timer to detect how long an acknowledgement state variable remains the same, wherein the acknowledgement state variable represents a sequence number (SN) of a protocol data unit (PDU); and
performing the RLC re-establishment procedure upon the expiration of the timer, wherein the timer is updated upon the occurrence of packet retransmissions.

5. A wireless communication method of detecting radio link failures, the method comprising:
initiating a medium access control (MAC) reset; and
initiating a radio link control (RLC) re-establishment procedure upon initiating the MAC reset.

6. The method of claim 5 further comprising:
initiating a packet data convergence protocol (PDCP) re-establishment procedure upon initiating the RLC re-establishment procedure.

7. The method of claim 5 further comprising:
using a counter to count a number of retransmissions of a protocol data unit (PDU) whose sequence number (SN) is represented by an acknowledgement state variable; and
performing the RLC re-establishment procedure when the counter reaches a certain threshold while the acknowledgement state variable remains the same, wherein the counter is updated upon the occurrence of packet retransmissions.

8. The method of claim 5 further comprising:
using a timer to detect how long an acknowledgement state variable remains the same, wherein the acknowledgement state variable represents a sequence number (SN) of a protocol data unit (PDU); and
performing the RLC re-establishment procedure upon the expiration of the timer, wherein the timer is updated upon the occurrence of packet retransmissions.

9. A wireless communication method of detecting radio link failures, the method comprising:
receiving a radio link control (RLC) indication that indicates that a maximum number of transmissions has been reached;
detecting an RLC radio link failure; and
initiating an RLC re-establishment procedure.

10. A wireless transmit/receive unit (WTRU) comprising:
a radio link control (RLC) layer configured to initiate an RLC re-establishment procedure; and
a packet data convergence protocol (PDCP) layer configured to initiate a packet data convergence protocol (PDCP) re-establishment procedure upon initiating the RLC re-establishment procedure.

11. The WTRU of claim 10 wherein the RLC re-establishment procedure is initiated subsequent to the detection of at least one RLC protocol layer error.

12. The WTRU of claim 10 further comprising:
a timer configured to detect how long an acknowledgement state variable remains the same, wherein the acknowledgement state variable represents a sequence number (SN) of a protocol data unit (PDU), wherein the RLC layer is configured to perform the RLC re-establishment procedure upon the expiration of the timer, wherein the timer is updated upon the occurrence of packet retransmissions.

13. The WTRU of claim 10 further comprising:
a counter configured to count a number of retransmissions of a protocol data unit (PDU) whose sequence number (SN) is represented by an acknowledgement state variable, wherein the RLC re-establishment procedure is performed when the counter reaches a certain threshold while the acknowledgement state variable remains the same.

14. A wireless transmit/receive unit (WTRU) comprising:
a medium access control (MAC) layer configured to initiate a MAC reset; and
a radio link control (RLC) layer configured to initiating an RLC re-establishment procedure upon initiating the MAC reset.

15. The WTRU of claim 14 further comprising:
a packet data convergence protocol (PDCP) layer configured to initiate a PDCP re-establishment procedure upon initiating the RLC re-establishment procedure.

16. The WTRU of claim 14 further comprising:
a timer configured to detect how long an acknowledgement state variable remains the same, wherein the acknowledgement state variable represents a sequence number (SN) of a protocol data unit (PDU), wherein the RLC layer is configured to perform the RLC re-establishment procedure upon the expiration of the timer, wherein the timer is updated upon the occurrence of packet retransmissions.

17. The WTRU of claim 14 further comprising:
a counter configured to count a number of retransmissions of a protocol data unit (PDU) whose sequence number (SN) is represented by an acknowledgement state variable, wherein the RLC re-establishment procedure is performed when the counter reaches a certain threshold while the acknowledgement state variable remains the same.

18. A wireless transmit/receive unit (WTRU) configured to:
receive a radio link control (RLC) indication that indicates that a maximum number of transmissions has been reached;
detect an RLC radio link failure; and
initiate an RLC re-establishment procedure.
